(19) United States
(12) Patent Application Publication
(10) Pub. No.: US 2006/0043278 A1
(43) Pub. Date: Mar. 2, 2006

(54) VCSEL pin sensor

(75) Inventors: Trevor T. Schelp, Dallas, TX (US); Ronald W. Chandler, Pittsburg, TX (US); James K. Guenter, Garland, TX (US); Norman B. Stapleton, Princeton, TX (US)

Correspondence Address: Kris T. Fredrick;Honeywell International Inc., 101 Columbia Rd., P.O. Box 2245, Morristown, NJ, 07962, US

(73) Assignee: Honeywell International Inc.

(21) Appl. No.: 11/203,928

(22) Filed: Aug. 15, 2005

Related U.S. Application Data
(60) Provisional application No. 60/605,897, filed on Aug. 30, 2004.

(51) Int. Cl. H01J 5/02

(52) U.S. Cl. 250/239

(57) ABSTRACT

A vertical cavity surface emitting laser (VCSEL) operable as a signal emitter and a silicon photodetector adapted for receiving light signals co-mounted in a common canister. Also containable is a four lead header and an isolating ceramic spacer. The canister can be electrically connected to a first lead from the header. The isolating ceramic spacer is adapted for mounting of the VCSEL above the level of the photodetector within the can. The VCSEL is electrically connectable to a second and third lead from the header and the photodetector is electrically connectable to the second and a fourth lead from the header. Co-packaging of a VCSEL and photodetector in common device canisters can yield about a 20:1 contrast ratio between an object's presence in front of the sensing system. A small pattern necessary for high accuracy is provided by the system and no barrier is necessary between the emitter and detector.

### APPLICATION PRIORITY

The present invention claims priority under 35 U.S.C. § 119(e) to previously filed U.S. Provisional Patent Application Ser. No. 60/605,987 entitled “Reflective Sensors,” which was filed Aug. 20, 2004, the prior specification being incorporated herein by reference.

### FIELD OF THE INVENTION

The present invention is related to reflective sensing devices and systems. More particularly, the present invention relates to a compact semiconductor laser and photodetector package capable of small pattern reflectivity and pattern geometry.

### BACKGROUND

Optical transceivers having a photodetector and a light emitting diode (LED) positioned adjacent to each other on the same plane use dedicated lenses or surfaces disposed over or between the photodetector and the LED. The lenses typically have a circular-shaped outer perimeter. A problem with prior devices is with excessive Link Turn Around Time (LTAT), which slows communications between the LED and photodetector. An LED can transmit enough light or optical rays to saturate an adjacent photodetector, thus rendering the photodetector temporarily unable to receive optical rays. The saturated photodetector requires a predetermined amount of time (i.e., LTAT) to recover and become normalized enough to then be ready to reliably detect incoming optical rays.

With prior art configurations, the communication process was required to wait for the saturated photodetector to normalize each time the adjacent LED completed a transmission cycle. A familiar example of a saturated optical sensor is a human eye that is exposed to too much light. This causes the retina to become temporarily blinded (i.e., saturated). Before the eye can once again detect images, the eye must normalize during a recovery time after the light is removed. Therefore, it is desirable to find a solution to overcome the problem of optically isolating the photodetector from the LED to avoid saturating the photodetector when the LED is adjacent to the photodetector for maintaining continued communication by eliminating the wait or idle time while the photodetector normalizes.

Some prior art methods have attempted to address the problem by interposing a physical barrier between the photodetector and the LED to block light or optical rays from leaving the LED and reaching the photodetector. This, however, causes a transceiver to become larger and more complicated. It is undesirable for portable computers or small-sized computing devices, like laptop computers or hand-held personal digital devices, to require an optical transceiver of a large size or form factor.

Another solution to solving the problem is to have the components an/or lenses separated further apart to keep the profiles of the emitter (LED) and receiver lenses from interfering with each other; however, the transceiver size will then be larger and thus less desirable for use in a portable PC. Therefore, a solution should address, balance, and satisfy several technical problems in combination.

What is needed are means to prevent degrading a transceiver's communication performance while satisfying limitations on size for position sensors and detectors. Therefore, another objective of this invention is to configure a transceiver having a small physical size for use in portable computing devices and the like.

There are at least two types of VCSEL—single-mode (SM) and multimode (MM). The modal nature here refers to the transverse-mode structure of the laser, which is controlled by the size of the VCSEL active area. The single-mode VCSEL offers the advantages of being the most efficient and coherent device with the narrowest divergence.

The present invention intends to solve the problem associated with repeatability of sensing the presence of small objects at relatively long distances by isolating the specific optical profiles for optimum condition of transmission and reception of optical rays; preventing a photodetector from becoming saturated by an adjacent light emitting component, thus not allowing the communication process to idle unnecessarily; minimizing the transceiver's package size; and communicating optical rays freely within the specified optical profiles. The present invention solves the problem by using VCSELs to provide transmission efficiency and accuracy within a common device.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

The present invention incorporates a vertical cavity surface emitting laser (VCSEL) and silicon photodetector packaged in a manner that yields a device that can possess an extremely high (e.g., ˜20:1) contrast ratio between an object's presence or not (dependent on its reflectivity and geometry). Standard IR reflective sensors can't achieve the small pattern necessary for high accuracy without expensive bulky optics. With VCSEL's no barrier is necessary between the emitter and the detector.

In accordance with features of the invention, a device is constructed with the multimode VCSEL mounted on an isolating ceramic spacer, and then attached to a 4 lead header (with one 1 lead being welded to the case). The photodetector is then situated on the header adjacent to the VCSEL and wire bonded to the remaining 3 leads.

In accordance with another feature of the invention, a dome lens can is then welded onto the header for optical performance and hermeticity.

In accordance with another feature of the inventing the Photodetector can be biased with 5 volts, and the VCSEL powered at 5 to 10 mA of current.

In accordance with another feature of the invention, a laser beam exits the package from the VCSEL, striking the reflective target and returns to the phototransistor where it is converted into a current signal.

In accordance with another feature of the invention, the current package configuration is tuned for approximately 12 mm, but both shorter and longer distances can be achieved by varying the lens design, the lens to VCSEL distance, and the spacing between the VCSEL and phototransistor.

### BRIEF SUMMARY OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a side view of the reflective sensing device in accordance with the embodiments.

FIG. 2 illustrates a top view of the reflective sensing device in accordance with the embodiments

FIG. 3 illustrates a top view of the reflective sensing device without a can and lens installed accordance with the embodiments.

FIG. 4 illustrates a side view of the reflective sensing device without a can and lens installed accordance with the embodiments.

FIG. 5 illustrates a close-up top view of a reflective sensing device shown with lead connected to photodetector, and leads electrically connected to VCSEL in accordance with the embodiments.

FIG. 6 illustrates a top view of the reflective sensing device including a photodetector with an integrated window in accordance with the embodiments.

FIG. 7 illustrates a top view of the device wherein a VCSEL can be located within the window of a photodetector in accordance with the embodiments.

FIG. 8 illustrates a side view of the reflective sensing device in operation with a ceramic spacer elevated VCSEL in accordance with the embodiments.

### DETAILED DESCRIPTION

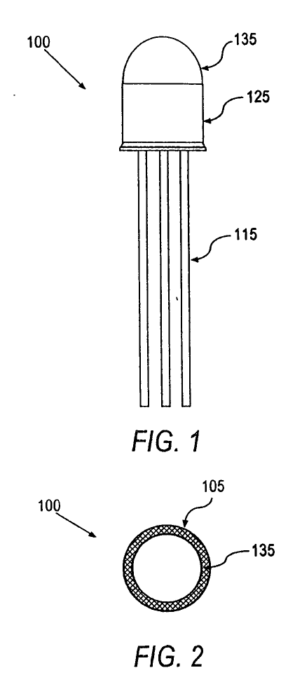

Referring to FIGS. 1 and 2, one form factor for a reflective sensing device 100 is shown. FIG. 1 illustrates a side view of the reflective sensing system 100. The system has a base 105 disposed between three pins 115 and a can 125 including an integrated glass lens 135 located near its top end. FIG. 2 illustrates a top view of the reflective sensing device 100, wherein the base 105 and lens 135 are shown. Light signals are transmitted and received through the lens 135 during system operation.

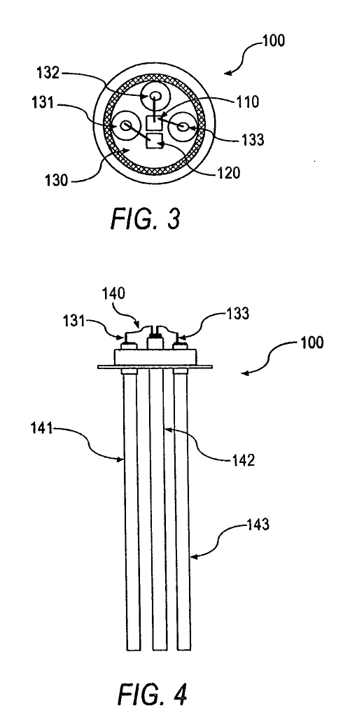

Referring to FIG. 3, a top view of the reflective sensing device 100 is shown without a can and lens installed. As shown in FIG. 3, the system 100 includes a multi-mode vertical cavity surface emitting laser (VCSEL) 110 operable as a signal emitter and a silicon photodetector 120 adapted for receiving light signals. A header 130 is included having at least three leads 131, 132 and 133 integrated therein. The header 130 actually forms part of the base 105, but supports a VCSEL 110 and photodetector 120 and enables their connection to the leads 131, 132 and 133.

Referring to FIG. 4, a side view of the reflective sensing device 100, again without the can and lens, is shown. A bond wire 140 is shown connecting the photodetector 120 to lead 131. Also shown in FIG. 4 is a pin 141 disposed opposite lead 131 and integrated with the header 130. Pin 141 electrically corresponds with lead 131, pin 142 electrically corresponds to lead 132 (not shown), and pin 143 electrically corresponds to lead 133.

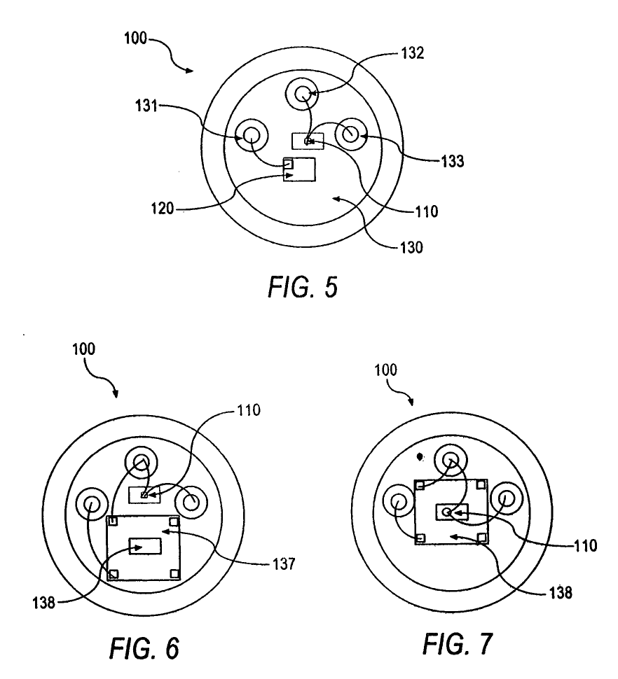

Referring to FIG. 5, a close-up top view of the reflective sensing device 100 is shown with lead 131 connected to photodetector 120, and leads 132 and 133 electrically connected to VCSEL 110. With the layout shown in FIG. 5, the components are separated in the real estate provided by header 130.

Referring to FIG. 6, the device 100 is shown including a photodetector 137 with an integrated window 138. With a photodetector 137 like the one shown in FIG. 6, a VCSEL can be located within the window 138 as shown in FIG. 7 of the system 100. With such a layout, the VCSEL 110 can be located beneath the photodetector surface 139, therefore light beams would not directly impinge on the photodetector from the VCSEL 110 during operation. Only returned light beams would be captured by the photodetector's surface 139, which is light sensitive and reactive to direct light from VCSEL 110.

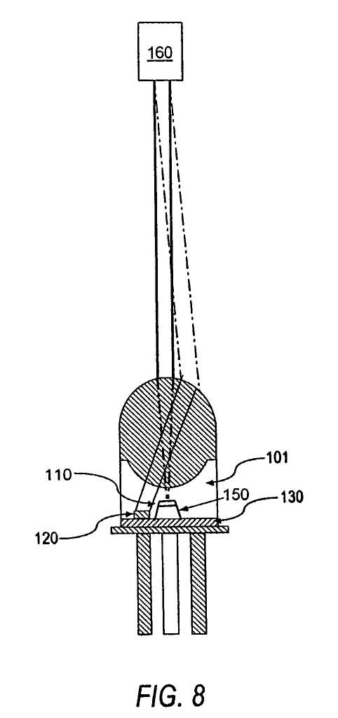

Referring to FIG. 8, a ceramic isolating spacer 150, which can be fabricated as part of the header, can be adapted for mounting VCSEL 110 at a level higher than the photodetector 120 within a can/housing 101. The can 101 covers and contains the header 130, the isolating ceramic spacer 140, the VCSEL 110 and the silicon photodetector 120.

The canister 101 is electrically conductive and can be electrically connected to a first lead from the header 130. The VCSEL 110 is electrically connected to a second and third lead from the header and the photodetector is electrically to the can and a fourth lead from the header. It should be appreciated that the can and header can be made from metal, kovar and other suitable materials known in the art.

The VCSEL 110 and the silicon photodetector 120 can be packaged in the can 101 as a common package in a manner that yields an extremely high (˜20:1) contrast ratio between an object's presence or not (dependent on its reflectivity and geometry). Standard IR reflective sensors can't achieve the small pattern necessary for high accuracy without expensive bulky optics. With VCSEL's no barrier is necessary between the emitter and the detector. VCSEL, Reflective Position Sensor, High Resolution, High Contrast Ratio.

The system can be designed so during operation the photodetector 120 can be biased with 5 volts, and the VCSEL 110 powered at 5 to 10 mA of current. The laser beam exiting the VCSEL 110 from the package 100, striking the reflective target and returns to the photodetector 120 where it is converted into a current signal.

The current package configuration can be tuned for approximately 12 mm, but both shorter and longer distances can be achieved by varying the lens design, the lens to VCSEL distance, and the spacing between the VCSEL and phototransistor.

Referring again to FIG. 8, an embodiment of the invention is shown in operation. VCSEL 110 transmits an optical signal towards an object. The object is depicted as square, however other shaped objects can be the subject of analysis. The object reflects a portion of the signal back towards device to the photodetector 120 which receives at least a portion of the reflected signal. When the received reflected portion of the signal exceeds a threshold, the device together with supporting logic (not shown) detects that object is present. On the other hand, when the received reflected portion does not exceed the threshold, the device will not detect the object and the object will be considered as not present.

Where various shapes are used as the target, different thresholds can be set up for detection. For example, when VCSEL 110 transmits an optical signal towards a round, the round object will reflect a lesser portion of the light (e.g., signal) back towards device because of the objects curvature. The photodetector will receive a portion of the reflected signal from the round object and, together with supporting electronic logic (not shown) determine if the returned signal matches a threshold. When the received reflected portion of the signal exceeds a threshold, device will have helped detect that a round object is present. On the other hand, if the received reflected portion does not exceed the threshold, the device will not determine that a round object is present.

As depicted, a smaller portion of signal is reflected by round object 309 than is reflected by square object 308. This lessened reflection is represented by only one return arrow being received at photodetector 303 as compared to two return arrows being received at photodetector 301. However, since a VCSEL has more focused power as compared to, for example, and LED, photodetector 307 can still correctly determine the presence or absence of round object 309 at 12 mm (or other distances ranging from 10-15 mm).

By using the technical features of the VCSEL, integrating a phototransistor in the package, and designing an optical element into the TO can lid, an effective reflective sensor can be developed. The advantages of the sensor include the ability to package the entire assembly in a single compact TO can, along with the focusing optics and a phototransistor (see FIG. 4). Depending on the application, a single-mode or multimode VCSEL can be used. In some cases, for example, when coherence of the optical beam is desired, the single-mode VCSEL might be the best choice, but in other cases, for example, when total output power is more important, a multimode VCSEL might be more beneficial.

For example, a multimode VCSEL can be mounted on the centerline of the lens and package, and the phototransistor mounted to the side of the VCSEL. In this configuration, the optimal signal is obtained by tilting the package with respect to the centerline of the TO. The optical system can be made by including a melt-formed glass lens in the TO lid. The lid can be designed to accept other lenses, and the height can be varied, which allows for the design of a wide variety of optical sensors. It should be appreciated that other materials known in the art for providing optical signal transmission qualities may be used for the lens besides glass.

In this example, we have implemented a focusing system that creates a focal spot about 15 mm from the lens surface. The VCSEL is driven with a simple constant current source to deliver approximately 1-mW total optical power. The phototransistor is biased with 5 V on the collector, and the emitter is grounded. The current into the collector is the measured sensor response. Alternatively, the emitter can be connected to a resistance to ground, and the voltage across the resistor can be monitored.

Typical S/N values obtained with the sensor are more than 20 dB, which is very difficult to achieve in reflective sensors. The S/N could be increased even more with the use of antireflection coated optics if desired. The high S/N and the compact focal spot make this optical sensor appropriate for difficult sensing environments, or when the object to be sensed does not provide a strong reflection. This sensor is particularly well suited for the detection of round objects, dirty objects, and other low-specular-reflection objects for which traditional LED sensors are limited.

To characterize the performance of the sensor, we measure the S/N as a function of four alignment variables ρ, θ, φ, and z (see FIG. 3). Mathematically, the response of the reflective sensor can be expressed as,

$$S / N ( ρ , ϕ , θ , z ) = \frac{{A}_{0}}{N} {ⅇ}^{\frac{- {( z - {z}_{o} )}^{2}}{2 {σ}_{z}^{2}}} {ⅇ}^{\frac{- {( ρ - {ρ}_{4} ( z ) )}^{2}}{2 {σ}_{p}^{2}}} {ⅇ}^{\frac{- {( ϕ - {ϕ}_{4} ( z ) )}^{2}}{2 {σ}_{o}^{2}}} {ⅇ}^{\frac{- {( 0 - {0}_{o} ( z ) )}^{2}}{2 {σ}_{o}^{2}}}$$

where N is the background noise level in the phototransistor, A0 is the efficiency factor, _{z}0 is the focal length of the lens, ρ₀(z), θ₀(z), φ₀(z) are the positions of the angular reflectance maxima at the various distances, and sx represents the tolerance for each degree of freedom. The values for A and s depend on the properties of the reflector, and z0 and ρ₀(z), θ₀(z), φ₀(z) depend on the optical design and the placement of the optoelectronic chips in the header

In this design example, the tolerance on both q and z are quite large (about 30° and 10 mm, respectively) because of the large phototransistor used. It is conceivable that an even larger phototransistor could eliminate the variance caused by these two degrees of alignment freedom.

For example, using a VCSEL sensor to sense a 1-mm diameter pin can achieve a 13-dB increase in the S/N, as well as improved position resolution over using a traditional “arrowhead” LED and detector-pair sensor. This is in part due to the more focused signal of the VCSEL (e.g., 0.5 mm) when compared to the LED (e.g., 7 mm).

In addition to the reduced power consumption and single-package interface, the VCSEL sensor can provide higher S/N in environments where the LED sensor is not able to adequately perform. Other application areas include the sensing of diffuse reflective surfaces such as paper in a printing system, or low-reflectivity surfaces such as glasses or plastics. The small focal spot also has significant advantages in optical encoding applications such as barcode reading or positioning equipment.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes, which come within the meaning and range of equivalency of the claims, are to be embraced within their scope.

1. An reflective sensor device for sensing the presence of an object, comprising:
a VCSEL for transmitting a signal that is to be reflected by the object when the object is present in front of the transmitted signal;
a lens for focusing the transmitted signal so as to increase the range at which the object can be accurately sensed
a photodetector for detecting reflected portions of the transmitted signal such that when the detected portions exceed a threshold the object is sensed as being in front of the transmitted signal; and
a header assembly, wherein the VCSEL and the photodetector are wire bonded to pins of the header assembly;
a can wherein the VCSEL and photodetector co-packaged with the header assembly.

2. The device as recited in claim 1, wherein the VCSEL and photodetector co-packaged in the can in a manner that yields about a 20:1 contrast ratio between an object's presence in front of the sensing system.

3. The device as recited in claim 1, wherein the VCSEL and photodetector co-packaged in the can in a manner that a small pattern necessary for high accuracy is provided by the system wherein no barrier is necessary between the emitter & the detector.

4. The device as recited in claim 1, wherein the photodetector is a phototransistor.

5. The device as recited in claim 1, wherein the VCSEL is mounted on top of the photodetector on a ceramic spacer.

6. The device as recited in claim 1, wherein the device is adapted to sense objects that are position from 10 mm to 15 mm in front of the sensor device.

7. The device as recited in claim 1, wherein the signal to noise ration of the sensor device is at least 20 dB.

8. The system of claim 1, wherein the photodetector is biased with 5 volts and the VCSEL is powered at 5 to 10 mA of current.

9. The system of claim 1, further comprising a dome lens integrated with the can that is welded onto the header for optical performance and hermeticity.

10. A reflective sensing system comprising:
a multi-mode vertical cavity surface emitting laser (VCSEL) operable as a signal emitter;
a silicon photodetector adapted for receiving light signals;
a header including at least four leads;
an isolating ceramic spacer;
a can adapted to contain the header, the isolating ceramic spacer, the VCSEL and the silicon photodetector, wherein the can is electrically connected to a first lead from the header; and
a isolating ceramic spacer adapted for mounting of the VCSEL and photodetector within the can, wherein the VCSEL is electrically connected to a second and third lead from the header and the photodetector is electrically connected to the second and a fourth lead from the header.

11. The system of claim 10 wherein the VCSEL and photodetector co-packaged in the case in a manner that yields about a 20:1 contrast ratio between an object's presence in front of the sensing system, wherein a small pattern necessary for high accuracy is provided by the system wherein no barrier is necessary between the emitter & the detector.

12. The system of claim 10, further comprising a dome lens integrated with the can that is welded onto the header for optical performance and hermeticity.

13. The system of claim 10 wherein the system is tuned for operation at about 12 mm.

14. The system of claim 10 wherein shorter and longer distances can be achieved by varying the lens design, the lens to VCSEL distance, and the spacing between the VCSEL and phototransistor.

15. A reflective sensing system comprising:
a multi-mode vertical cavity surface emitting laser (VCSEL) operable as a signal emitter;
a silicon photodetector adapted for receiving light signals;
an isolating ceramic spacer for mounting and supporting the VCSEL;
a header including at least four leads, wherein the VCSEL is electrically connected to a second and third lead from the header and the photodetector is electrically connected to the second and a fourth lead from the header;
a can adapted to contain the header, the isolating ceramic spacer, the VCSEL and the silicon photodetector, wherein the can is electrically connected to a first lead from the header and wherein the isolating ceramic spacer supports the VCSEL's position over the photodetector's position within the can; and
a dome lens integrated with the can for optical performance and hermeticity.

16. The system of claim 15 wherein the dome lens is welded to the can.

17. The system of claim 15 wherein the system is tuned for operation in sensing object located at about 12 mm distance from the device.

18. The system of claim 15 wherein the VCSEL and photodetector co-packaged in the case in a manner that yields about a 20:1 contrast ratio between an object's presence in front of the sensing system, wherein a small pattern necessary for high accuracy is provided by the system wherein no barrier is necessary between the emitter & the detector.

19. The system of claim 15 wherein shorter and longer distances can be achieved by varying the lens design, the lens to VCSEL distance, and the spacing between the VCSEL and phototransistor on the header.
